(19) United States
(12) Patent Application Publication
(10) Pub. No.: US 2008/0121167 A1
(43) Pub. Date: May 29, 2008

(54) Automatic apparatus for raising and lowering a flag on a flag pole

(76) Inventors: Bart A. Randall, Chamberlain, SD (US); Ryan Randall, Chamberlain, SD (US)

Correspondence Address: iPA, STE. 101, 400 GARDEN CITY PLAZA, GARDEN CITY, NY, 11530, US

(21) Appl. No.: 11/604,383

(22) Filed: Nov. 27, 2006

(51) Int. Cl. G09F 17/00

(52) U.S. Cl. 116/173

(57) ABSTRACT

An electrically operated apparatus is provided for raising a flag on a flag pole for display, and later lowering a flag on the flag pole into a storage box for safe storage. The disclosed apparatus permits these steps to be performed remotely or automatically by use of electrically operated drives. The apparatus can be operated remotely, say from inside a home or office, thereby greatly easing the task of raising and lowering the flag. Additionally, the apparatus is operable from a timer or a light sensor.

### FIELD OF THE DISCLOSURE

The disclosures made herein relate generally to a flag pole and an apparatus for raising and lowering a flag on the flag pole and, more particularly, to a flag pole having a flag storage box and an electric drive means for automatically retrieving the flag from the storage box and raising the flag up the pole, then later lowering the flag down the pole and placing it into the storage box.

### BACKGROUND

Flag poles and manual operated rope apparatus for raising and lowering flags are well known in the art. Flags are typically raised and lowered manually by a human operator untying a rope from a clevis or rope attachment device on the flag pole, then manually operating the rope to raise and lower the flag up and down the flag pole. Out of respect for country, the flag is typically lowered in the evening as well as during bad weather such as rain storms, high winds, and snow or sleet. Once the flag is lowered from the pole it is normally folded and stored in a safe environment. Manually lowering a flag is not always convenient or possible. Due to this fact flags are often left raised on the flag pole during the evening, in storms and in high winds because of the time consuming process required to lower and store the flag. As conventional flag raising and lowering methods require a person out by the flag pole to raise or lower the flag and then remove, fold and store the flag, flags are typically left on the flag pole in bad weather. As a result, the life of the flag is greatly reduced and in high winds tears and damage to the flag may result.

Therefore, there exists a need for an electrically operated flag raising and lowering apparatus for a flag pole that overcomes the drawback of conventional manual approaches to the raising, lowering and storing of the flag.

### SUMMARY OF THE DISCLOSURE

The inventive disclosures herein provide an electrically operated apparatus for raising a flag on a flag pole for display and later lowering a flag on the flag pole into a storage box for safe storage. The disclosed apparatus permits these steps to be performed using electrically operated mechanisms. The apparatus can be operated remotely, say from inside a home or office, thereby greatly easing the task of raising and lowering the flag.

In various embodiments the apparatus includes a closed flag storage box located at the lower portion of the flag pole. The flag storage box is provided with one or more lids that are electrically operable between a closed and open position. The flag storage box provides sheltered storage for the flag when the flag is not raised for display. The apparatus includes an upper pulley secured proximate to an upper end of the flag pole and a lower pulley secured in the flag storage box at the lower end of the flag pole. An elongated section of rope is provided with the rope ends secured together to form a closed loop rope. The rope is received around the upper and lower pulleys with the loop sized to hold the rope taunt between the upper and lower pulleys. A reversible electrically operated drive means driveably engages the rope and loop and is operable to move the flag between a raised display position and the lowered storage position where the flag is stored within the storage box and out of the elements.

Accordingly, it is a primary objective of the invention to provide a flag raising and lowering apparatus that eliminates the need to have a human operator at the flag pole to manually raise and lower the flag.

It is another objective of the inventive disclosures herein to remove the need for a person to stand outside in the rain or inclement weather to raise or lower the flag.

It is another objective of the inventive disclosures herein to provide a flag raising and lowering apparatus that eliminates the need to manually fold and store the flag in times when the flag is not displayed.

It is another objective of the inventive disclosures herein to provide a flag raising and lowering apparatus that can be operated electrically from a remote location.

It is another objective of the inventive disclosures herein to provide a flag raising and lowering apparatus that can be retrofitted onto existing flag poles.

It is another objective of the inventive disclosures herein to provide a flag raising and lowering apparatus that in certain embodiments includes a light sensor to initiate raising of the flag at daybreak and later lowering of the flag at dusk.

It is another objective of the inventive disclosures herein to provide a flag raising and lowering apparatus that can be operated automatically by a programmable timer.

### BRIEF DESCRIPTION OF THE DRAWINGS

The drawings show a form of the invention that is presently preferred; however, the invention is not limited to the precise arrangement shown in the drawings.

FIG. 1 is a perspective view of the automatic apparatus for raising and lowering a flag on a flag pole.

FIG. 2 is an enlarged view of the reversible electric drive depicted in FIG. 1 and identified by the view label ‘A’.

FIG. 3 is one embodiment of an electric raise/lower switch operable to command the apparatus of FIG. 1 to raise or lower the flag.

FIG. 4A and FIG. 4B is a perspective view of one embodiment of the electrically operated lid pivot means comprising electrically operated solenoids.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

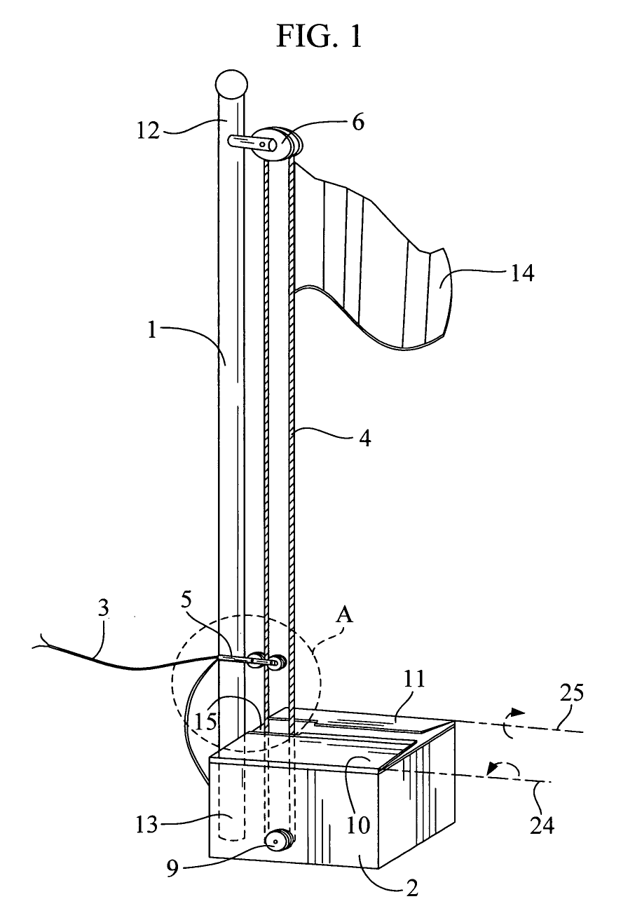

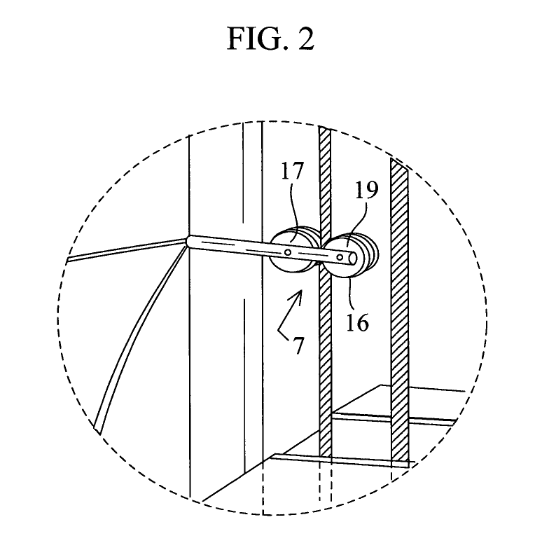

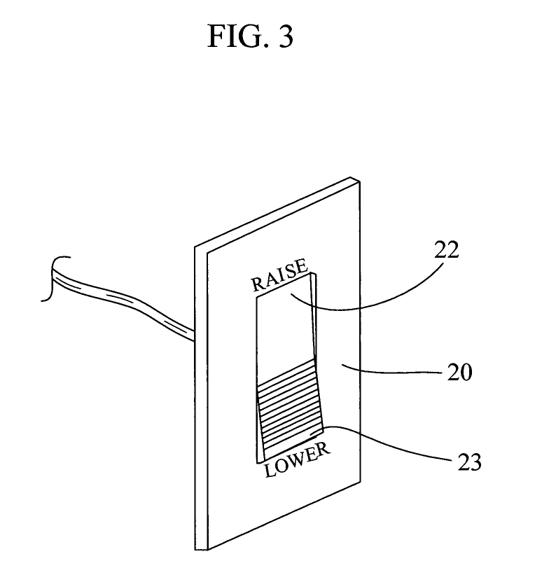

Turning now to FIG. 1 through FIG. 3:

FIG. 1 is a perspective view of the automatic apparatus for raising and lowering a flag on a flag pole. A vertically elongated flag pole 1 is adapted for displaying one or more flags 14 in a raised position on the pole 1. The flag 14 is secured to the closed loop rope 4. The closed loop rope is tensioned between the upper pulley 6 rotably secured to the flag pole 1 near to the upper end 12 and the lower pulley 9 rotably secured within the flag storage box 2. The flag storage box 2 is secured to the flag pole neat the lower end 13 of the flag pole 2 and is sized and adapted to receive and store the flag 14 when the flag is lowered by the directed movement of the closed loop rope 4 and the pulleys 6 and 9.

In a conventional flag pole a human operator would manually operate the rope 4 to raise and lower the flag. After lowering the flag at dusk a human operator would need to dismount the flag 14 from the rope 4, fold the flag and transport the flag indoors for storage. At dawn the human operator would need to take the flag from storage, unfold the flag, mount the flag 14 to the rope 4, then raise the flag 14 on the flag pole 1 by manually operating the rope 4 and pulley 6, 7 system.

Instead of the conventional manual methods discussed above, in the present inventive disclosures the flag 14 is raised and lowered on the flag pole 1 by the operation of the electrically operated rope drive means 7 and the flag is automatically stored in the flag storage box 2 when the flag is lowered and removed from display.

The flag is raised as follows. The user operates the raise/lower switch 20 to move the switch into the ‘Raise’ position 22. The switch may be located conveniently indoors at some distance from the flag pole 1. The switch is electrically connected to the electric drive means 7 by a multi-conductor wire 3. When the switch 20 is placed in the Raise position 22, the electrically operated lid pivot means 18 is actuated to pivotally raise and open the left box lid 10 and right box lid 11 of the flag storage box 2. The lids are hingeably attached to opposing sidewalls of the flag storage box 2. The left lid 10 pivots about axis 24 and the right lid pivots about axis 25 to place the lids in a substantially upright position providing an opening through with the flag may be drawn from the box. The drive means 7 is actuated by the raise/lower switch and drives the closed loop rope 4 to raise the flag 14 from the flag storage box 2 to an elevated position near the upper end 12 of the flag pole 1. The drive means 7 deactivates and the electrically operated lid pivot means 18 de-energizes thereby allowing the lids 10 and 11 to pivot downwards to a closed position upon the flag storage box 2.

When later lowering the flag, the raise/lower switch is moved to a Lower position 23, which energizes the electrically operated lid pivot means 18 to pivotally raise and open the left and right flag storage box lids 10, 11. The electric drive means is actuated in a reverse direction to operate the close loop rope 4 to lower the flag 14 down the flag pole and into the flag storage box 2 through the open left lid 10 and right lid 11 of the box. The drive means 7 deactivates and the electrically operated lid pivot means 18 de-energizes thereby allowing the lids 10 and 11 to pivot downwards to a closed position upon the flag storage box 2, thereby sheltering the flag.

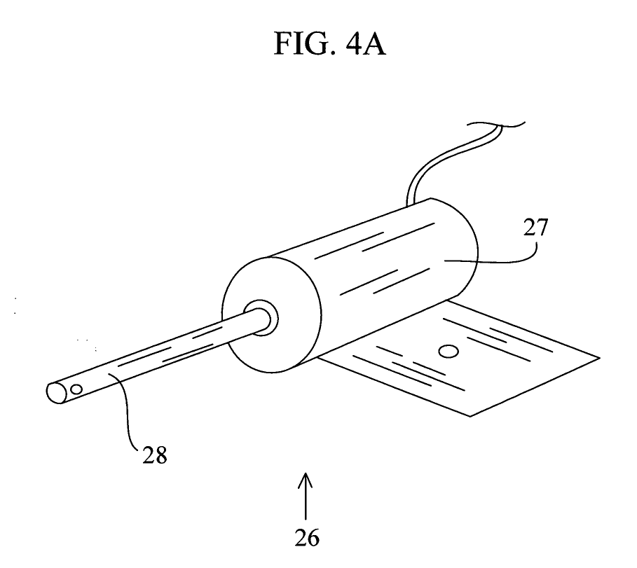

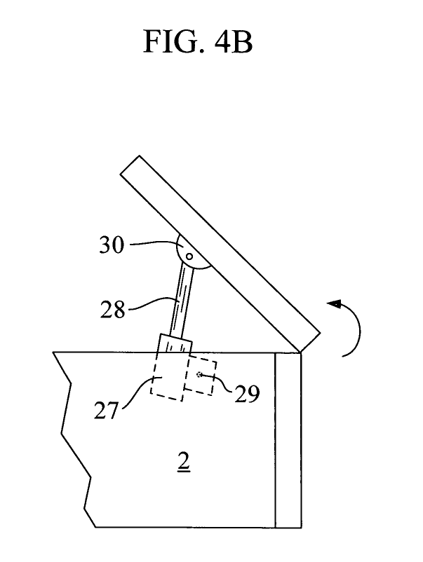

In FIG. 4A and FIG. 4B, in one embodiment the electrically operated lid pivot means 18 comprises electrically operated solenoids 26, one for each lid. The solenoid comprises a coil 27 and a plunger 28 which is slidably received into the coil. The solenoid coil is mounted to a wall of the flag storage box 2 by a pivoting mount 29 such as a screw or rivet. The plunger 28 is pivotally mounted to the lid (10 or 11) by a bracket 30. When the solenoid 26 is energized, the plunger 28 is urged outwards from the coil, thereby raising the lid (10 or 11). When de-energized, the weight of the lids causes the lids to close back onto the flag storage box 2.

In at least one embodiment, the electric drive means 7 comprises an electric motor 5 drivably engaged to a drive pulley 16. The drive pulley 16 is provided with a circumferential groove 19 into which the rope 4 is received and engaged by the drive pulley. The groove 19 is sized such that the rope 4 must be compressed somewhat in size when received into the circumferential groove 19 such that the drive pulley 16 is able to operate the rope 4 due to the friction between the rope 4 and the drive pulley 16. The rope is urged and compressably engaged into the drive pulley 16 by the compression pulley 17. The compression pulley 17 lacks a groove and serves to urge and compress the rope 4 into the circumferential groove 19 of the drive pulley 16 resulting in the drive pulley driveably engaging the closed loop rope 4 such that rotating the drive pulley causes the rope to move with the pulley.

In at least one embodiment the automatic apparatus for raising and lowering a flag on a flag pole includes a light sensor (not shown) operable to automatically raise the flag at daybreak and to lower and store the flag at sunset by triggering the electric drive means 7 and the electrically operated lid pivot means 18 without human interaction or input.

In at least one embodiment the automatic apparatus for raising and lowering a flag on a flag pole includes a programmable timer (not shown) operable to automatically raise the flag at daybreak and to lower and store the flag at sunset by triggering the electric drive means 7 and the electrically operated lid pivot means 18 without human interaction or input.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus for automatically raising or lowering at least one flag, the apparatus comprising:
an elongated flag pole configured for displaying the flag, the pole having an upper and a lower end;
a flag storage box for receiving and storing the flag, the box secured to the flag pole proximate to the lower end of the flag pole, the storage box comprising:
a closed rectangular box-like structure having four connected sidewalls, the sidewalls connected to a bottom wall, the box sized to receive at least one flag for storage;
a left lid and a right lid, the lids sized to substantially close the top of the storage box when in a closed position, the lids hingeably connected to opposing sidewalls of the storage box permitting the lids to pivot upwards to an open position, the open position permitting the flag to be received into the storage box or permitting the flag to be raised from the storage box up the flag pole; and
a lower pulley rotably secured to an inside surface of the storage box;
an upper pulley rotably secured to the flag pole proximate to the upper end of the flag pole;
an elongated section of rope having two ends, the rope ends secured together to form a closed loop, the rope received through the upper and lower pulleys, the rope loop sized to hold the rope taunt between the upper and lower pulleys;
the flag having one edge removably secured to a portion of the rope;
a reversible electrically operated drive means engaged with the closed loop rope for driving the closed loop rope, the drive means secured to the flag pole, the drive means electrically reversible in direction to permit raising or lowering the flag on the flag pole;
an electrically operated means of pivoting the left and right box lids between the closed and open position;
electronic controls interfaced to the reversible electrically operated drive means and the electrically operated means of pivoting the left and right box lids.

2. The apparatus of claim 1, wherein the electrically operated means of pivoting the left and right lids is electrically connected to the reversible drive means to open the left and right lids whenever the reversible electrically operated drive means is operating.

3. The apparatus of claim 2, wherein the reversible electric drive means comprises:
an electric drive motor having an electrically reversible output shaft, wherein the direction of shaft rotation can be selected by electrical input;
a drive pulley, the drive pulley having a circumferential groove sized for receiving and drivably engaging the closed loop rope, the drive pulley engaged with the motor shaft such that the motor drives the drive pulley;
a compression pulley, the compression pulley positioned proximate to the drive pulley to compressably engage the rope into the circumferential groove of the drive pulley.

4. The apparatus of claim 3, wherein the electric drive motor is positioned between the upper pulley and the lower pulley.

5. The apparatus of claim 2, wherein the electronic controls include a raise/lower switch operable to initiate raising or lowering of the flag on the flag pole.

6. The apparatus of claim 2, wherein the electronic controls include a light sensor, the light sensor operable to automatically raise the flag at daybreak and to lower and store the flag at sunset.

7. The apparatus of claim 2, wherein the electrically operated means of pivoting comprises two solenoids, one for each lid, each solenoid having a coil portion secured to a wall of the flag storage box and a plunger portion secured to the lid, wherein the solenoid when energized urges the plunger to extend and urges the lid to open.

8. The apparatus of claim 2, wherein the electronic controls include a timer programmable to automatically raise the flag at daybreak and to lower and store the flag at sunset.
